(19) United States
(12) Patent Application Publication
(10) Pub. No.: US 2025/0343413 A1
(43) Pub. Date: Nov. 6, 2025

(54) GENERATED-POWER PREDICTION METHOD, GENERATED-POWER PREDICTION DEVICE, AND SOLAR POWER GENERATION SYSTEM

(71) Applicant: LAPLACE SYSTEM CO., LTD., Kyoto-shi, Kyoto (JP)

(72) Inventors: Masayuki HORII, Kyoto-shi, Kyoto (JP); Hiroyuki FUJIMURA, Kyoto-shi, Kyoto (JP)

(21) Appl. No.: 18/696,875

(22) PCT Filed: Sep. 28, 2022
(86) PCT No.: PCT/JP2022/036193

§ 371 Date: Oct. 30, 2024

(30) Foreign Application Priority Data
Sep. 28, 2021 (JP) 2021-157627

(51) Int. Cl. H02J 3/00

(52) U.S. Cl. CPC H02J 3/004; H02J 2300/24

(57) ABSTRACT

A prediction method of solar-generated power includes: storing past data obtained by associating weather data and power generation data of a solar cell output via a PCS for at least one year before a prediction target day; calculating a sunny power generation curve from the past data; obtaining an annual transition curved line indicating an annual transition of a total power generation amount; obtaining a sunny power generation model from the sunny power generation curve so as to match the annual transition curved line; obtaining a the sunny power generation model for the entire year; obtaining a weather coefficient; and acquiring a weather forecast and obtaining prediction generated power from the sunny power generation model and the weather coefficient.

### CROSS REFERENCE TO RELATED APPLICATIONS

The present application is a U.S. National Phase of International Application No. PCT/JP2022/036193 entitled “METHOD FOR PREDICTING GENERATED POWER, DEVICE FOR PREDICTING GENERATED POWER, AND SOLAR POWER GENERATION SYSTEM,” and filed on Sep. 28, 2022. International Application No. PCT/JP2022/036193 claims priority to Japanese Patent Application No. 2021-157627 filed on Sep. 28, 2021. The entire contents of each of the above-listed applications are hereby incorporated by reference for all purposes.

### TECHNICAL FIELD

The present invention relates to a generated-power prediction method for solar power generation, a generated-power prediction device, and a solar power generation system.

### BACKGROUND ART

Hitherto, there has been known a solar power generation system for generating power with use of sunlight as renewable energy. In solar power generation, generated power is affected by meteorological conditions. Accordingly, in order to efficiently utilize the power generated by sunlight, it is desired to predict the generated power.

For example, Patent Literature 1 and Patent Literature 2 disclose a prediction method of solar-generated power.

### CITATION LIST

### Patent Literature

Patent Literature 1:

Japanese Patent Laid-Open No. 2017-127140
Patent Literature 2:

Japanese Patent Laid-Open No. 2012-124188

### SUMMARY OF INVENTION

### Technical Problem

The related-art prediction method of generated power is based on an amount of insolation, and requires a correlation between an actual measurement value of the amount of insolation and an actual measurement value of the generated power. The actual measurement value of the amount of insolation available from the Internet is limited, and, in order to obtain an accurate actual measurement value of the amount of insolation at a location where a solar cell is installed, it is required to install a pyranometer.

The present invention has an object to provide a prediction method of solar-generated power, a solar power generation prediction device, and a solar power generation system with which generated power at a desired date/time can be predicted without requiring a pyranometer in a solar power generation system.

Note that the solar power generation system means a power generation system including a solar cell and a power conditioning system.

### Solution to Problem

A prediction method of generated power according to the present invention is a prediction method of generated power for a solar power generation system including a solar cell and a power conditioning system, the prediction method including:
a first step of storing past data obtained by associating weather data and power generation data of the solar cell output via the power conditioning system for at least one year before a prediction target day of the generated power;
a second step of obtaining a sunny power generation curve from a generated-power value of a day selected from the past data;
a third step of obtaining an annual transition curved line indicating an annual transition of a total power generation amount obtained by integrating the sunny power generation curve;
a fourth step of obtaining a sunny power generation model by scaling the sunny power generation curve so as to match the annual transition curved line;
a fifth step of obtaining the sunny power generation model for all days in one year;
a sixth step of obtaining a weather coefficient corresponding to each weather; and
a seventh step of acquiring a weather forecast of the prediction target day and predicting the generated power to be output from the power conditioning system from the weather coefficient and the sunny power generation model of the prediction target day,
the steps being executed in the stated order.

With such a prediction method of generated power, the generated power of the solar power generation can be predicted without requiring a pyranometer.

Further, in the prediction method of generated power according to the present invention,
the sunny power generation curve is expressed by a function that is axisymmetric with respect to a time axis at a middle of a power generation time period.

With use of such a function, the sunny power generation curve can be reproduced with a smaller number of parameters.

Further, in the prediction method of generated power according to the present invention,
in the second step, the selected day has a total sunny time period of 40% or more with respect to a total power generation time period.

With such a configuration, the number of days for which the sunny power generation curve can be calculated is increased. Accordingly, the number of data points for forming the annual transition curved line is increased, and thus an effect of improving the accuracy of prediction can be obtained.

Further, in the prediction method of generated power according to the present invention,
the weather coefficient is defined for each time or each month.

With such a configuration, finer prediction of the generated power is allowed.

Further, in the prediction method of generated power according to the present invention,
in the step 2,
the generated-power prediction device obtains the sunny power generation curve based on a generated-power value at a time at which the generated-power value becomes equal to or lower than rated output of the power conditioning system, and
in the step 7, a minimum value between the rated output and the prediction generated power calculated from the weather coefficient and the sunny power generation model at each time is adopted as the prediction generated power of the corresponding time.

With such a configuration, for example, even when peak shaving occurs in a solar power generation system having the solar cell overloaded thereon, the prediction of the generated power is allowed.

Further, in the prediction method of generated power according to the present invention,
through comparison between generated power output from the power conditioning system actually measured on the prediction target day, and a prediction generated power, the prediction generated power after the prediction target day is corrected.

With such a configuration, the accuracy of the prediction of the generated power can be further improved.

A solar power generation system according to the present invention is a solar power generation system including a solar cell, a power conditioning system, and a generated-power prediction device,
the generated-power prediction device being configured to execute the prediction method described in any one of claims 1 to 6.

With such a solar power generation system, the power generated by sunlight can be predicted without requiring a pyranometer.

A generated-power prediction device according to the present invention is a generated-power prediction device for predicting generated power of a solar power generation system including a solar cell and a power conditioning system,
the generated-power prediction device including an arithmetic processing unit and a memory unit,
the arithmetic processing unit being configured to execute the prediction method described in any one of claims 1 to 6.

The power generation prediction device can be incorporated into an existing solar power generation system including a solar cell and a power conditioning system, which makes it possible as a result to construct a solar power generation system capable of predicting generated power.

### Advantageous Effects of Invention

According to the present invention, it is possible to obtain the prediction method of solar-generated power, the solar power generation prediction device, and the solar power generation system with which the generated power at the desired date/time can be predicted without requiring a pyranometer.

### BRIEF DESCRIPTION OF DRAWINGS

FIG. 1 is a concept diagram showing a main configuration of a solar power generation system 100.

FIG. 2(A) is a graph exemplifying a temporal transition (time dependence) of an actual measurement value of generated power on a day that is sunny all day. FIG. 2(B) is a graph exemplifying an approximation curved line (referred to as “sunny power generation curve”) reproducing the time dependence of the generated power (actual measurement value).

FIG. 3 shows time dependence of generated power of a solar cell 2, which shows an example of a day that is partly sunny.

FIG. 4 is a graph showing an annual transition of a sunny-day total power generation amount, and showing an annual transition curved line for approximating the annual transition of the sunny-day total power generation amount.

FIG. 5(A) shows an example of a partly sunny day that cannot be corrected to the day that is sunny all day by interpolation, and FIG. 5(B) shows an example of a sunny power generation curve that is created based on the actual measurement value of the generated power on the partly sunny day.

### DESCRIPTION OF EMBODIMENTS

Embodiments of the present invention will be described below with reference to the drawings. However, none of the following embodiments is intended to limit the recognition of the gist of the present invention. Moreover, the same or similar members may be denoted by the same reference symbols, and description thereof may be omitted.

The term “generated power” described below refers to a power generation capacity of generating power per unit time, and is expressed in a unit of, for example, kW, and “power generation amount” refers to an integrated value of generated power in a predetermined time period (for example, total power generation time period in one day), and is expressed in a unit of, for example, kWh.

### First Embodiment

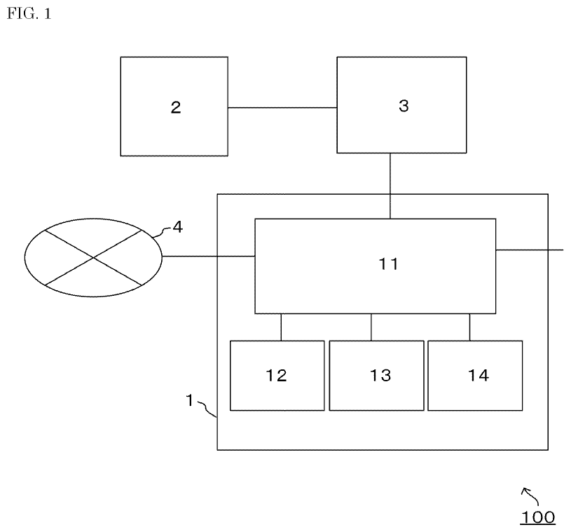

FIG. 1 is a schematic diagram showing a main configuration of a solar power generation system 100.

The solar power generation system 100 of the first embodiment includes a generated-power prediction device 1, a solar cell 2, and a power conditioning system 3.

DC generated power of the solar cell 2 is converted into AC power via the power conditioning system 3 (referred to as “PCS”) to be output to a load (not shown). As the solar cell 2 and the PCS 3, a known power conditioning system can be used.

As the PCS 3, there can be used a device that can receive power generated by the solar cell 2, perform control so as to improve power generation efficiency of the solar cell 2 in accordance with an IV characteristic of the solar cell 2, and output the generated power. For example, as the PCS 3, there can be used a device that can control the output by the hill climbing method or the like so that the generated power output by the solar cell 2 is maximum, thereby being capable of improving the power generation efficiency of the solar cell 2.

The PCS 3 outputs a generated-power value (output value of the generated power) to the generated-power prediction device 1.

Note that a wattmeter for measuring the generated power output from the PCS 3 may be separately provided, and the wattmeter may be configured to output the measured generated-power value to the generated-power prediction device 1.

Thus, the generated-power prediction device 1 can acquire the generated power of the solar cell 2 output via the PCS 3.

The generated-power prediction device 1 includes an arithmetic processing unit 11 and a memory unit 12.

The arithmetic processing unit 11 of the generated-power prediction device 1 can receive as input the generated-power value that changes moment by moment from the PCS 3. The arithmetic processing unit 11 can record the generated-power value into the memory unit 12 together with a date/time, and also read out the generated-power value recorded in the memory unit 12. As the arithmetic processing unit 11, a known microprocessor or the like can be used. As the memory unit 12, a semiconductor memory or a known device that stores data by an electromagnetic method can be used.

Note that the generated-power prediction device 1 may be installed at an installation location of the solar cell 2, or may be disposed at a different place such as a remote location connected to a network. The generated-power prediction device 1 is only required to be connected to the PCS 3 or the wattmeter by data communication means such as the Internet or a LAN so that the generated-power value can be received. The generated-power prediction device 1 may be disposed in, for example, a monitoring room or the like, or may be disposed in a remote terminal.

Further, the generated-power prediction device 1 is only required to include the arithmetic processing unit 11 and the memory unit 12. Accordingly, the generated-power prediction device 1 can be configured as one device with use of an independent computer or the like such as a so-called IoT device. Besides, for the generated-power prediction device 1, a computer on the cloud may be used, or an arithmetic processing unit and a memory unit incorporated in a monitoring device or the like configured to monitor or visualize the generated power may be used. Further, for the generated-power prediction device 1, an arithmetic processing unit and a memory unit included in a control device of the PCS 3 can be utilized.

Further, each step included in the prediction method described below can be performed by a plurality of different computers or other devices, and the generated-power prediction device 1 may be formed of a plurality of arithmetic processing units 11 and/or memory units 12.

The generated-power prediction device 1 can be connected to an Internet (line) 4 via a network interface (not shown), and can acquire meteorological information, such as cloud cover, air temperature, and humidity, and a weather forecast via the Internet 4. The meteorological information and the weather forecast can be recorded into the memory unit 12 together with the date/time, and the meteorological information and the weather forecast recorded in the memory unit 12 can be read out.

Note that the generated-power prediction device 1 can acquire, as the meteorological information, current or past meteorological information.

The generated-power prediction device 1 may be capable of outputting a picture signal, or may include a display device 13, for example, a flat panel display or the like. In this case, the generated-power prediction device 1 can output the generated-power value of the solar cell 2 to the display device 13 so as to visualize the generated-power value.

The generated-power prediction device 1 can receive an instruction of an operator via an input device 14 such as a keyboard, a touch panel, or voice input, for example. Note that the display device 13 can be configured as the input device 14 by installing a function of a touch panel.

The memory unit 12 stores, for each predetermined time period, the generated-power value of the solar cell 2 of each day in a past year. For example, the memory unit 12 stores, for example, for each minute, the generated-power value in a past year (from January 1st to December 31st).

Description is hereinafter given of a method of predicting the generated power of the solar cell 2 by the generated-power prediction device 1.

Step 1: Power generation and weather data before a prediction day is prepared.

Power generation data and weather data of January 1st to December 31st before a prediction day (prediction target day) are prepared.

The generated-power prediction device 1 stores and accumulates, into the memory unit 12, past data obtained by associating, for each day, the generated power of each time of the solar cell 2 output via the PCS 3 for each month/day/hour/minute and weather information (cloud cover, air temperature, and humidity) including at least the cloud cover acquired from the Internet 4 or the like with each other as the power generation data and the weather data.

Note that it is only required to use the power generation data and the weather data of at least a past year from a day for which the prediction is executed (appointed day), and the starting point of the power generation data and the weather data is not limited to January 1st. Further, the past data of the power generation data and the weather data of more than one year may be stored in the memory unit 12.

Step 2: A sunny day is selected (extracted) from the past generated-power data, and a sunny power generation curve (sunny power generation curved line) is obtained from an actual measurement value of the generated power at this sunny time.

From the actual measurement value of the past generated power stored in the memory unit 12, a day that is entirely sunny from a power generation start time (or sunrise) to a power generation end time (or sunset) is selected. The selected (extracted) day is hereinafter sometimes referred to as “selected day.”

Note that a period from the power generation start time (or sunrise) to the power generation end time (or sunset) is sometimes simply referred to as “all day,” and a day that is entirely sunny from the power generation start time to the power generation end time is sometimes referred to as “day that is sunny all day.”

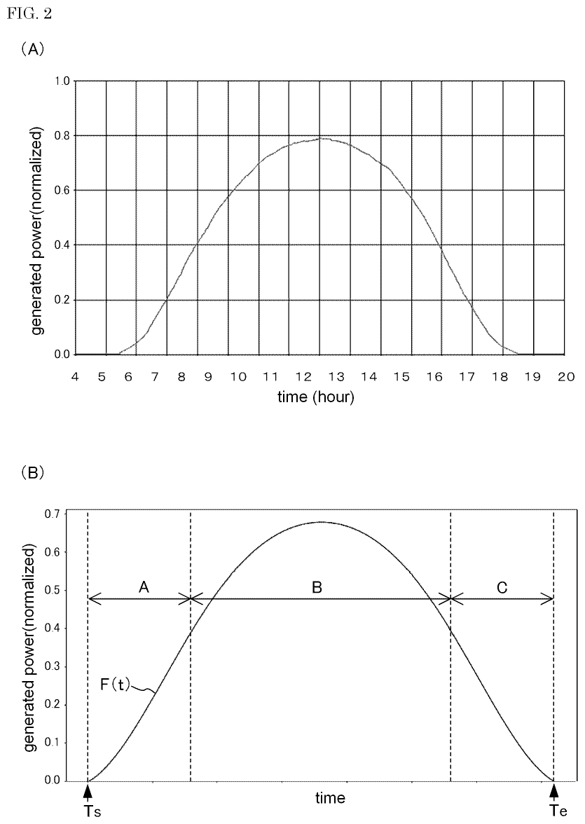

FIG. 2(A) is a graph exemplifying a temporal transition (time dependence) of the actual measurement value of the generated power in the day that is sunny all day. The vertical axis indicates a value obtained by normalizing the generated-power value with rated power of the PCS 3 (=[generated-power value]/[rated power of PCS 3]), and the horizontal axis indicates time.

FIG. 2(B) is a graph exemplifying an approximation curved line (referred to as “sunny power generation curve”) reproducing the time dependence of the actual measurement value of the generated power. In the following, as the generated power and the power generation amount, values obtained through normalization with the rated power of the PCS 3 are used. Note that the rated power of the PCS 3 is the maximum power value that can be output by the PCS 3.

The day that is sunny all day can be selected based on the shape of the graph showing the time dependence of the generated power (actual measurement value). For example, as shown in FIG. 2(A), from the fact that the shape of the graph of the time dependence of the generated power (actual measurement value) is a shape similar to the Gaussian distribution as a whole and is a gentle curved line, it can be judged that this is data of generated power of a day that is sunny all day.

As described later, it is possible to automatically determine whether or not the weather is sunny at each time from the value of the generated power, and thus it is possible to select the day that is judged as being sunny all day as the day that is sunny all day. Such selection of the day that is sunny all day can be performed by sequentially reading out, by the arithmetic processing unit 11, the actual measurement value of the past generated power, which is stored in the memory unit 12, and determining whether or not the selected day is the day that is sunny all day through automatic determination. The day determined as being the day that is sunny all day is registered as the day that is sunny all day in the memory unit 12.

Further, the sunny day to be selected may be not only a day that is sunny all day, but also a day that is partly sunny at a specific time (referred to as “partly sunny day”).

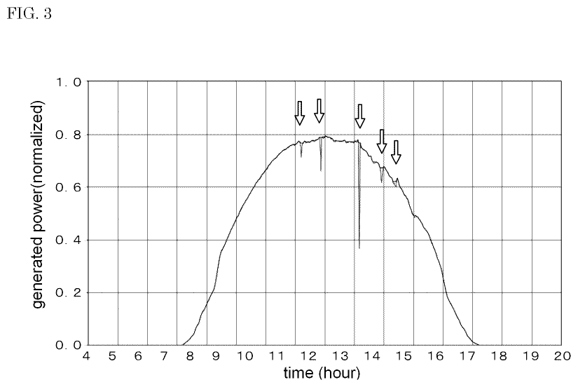

FIG. 3 shows a time dependence of the generated power of the solar cell 2, which shows an example of a day that is partly sunny.

It is understood in FIG. 3 that, at times indicated by white arrows, the generated power greatly fluctuates. The generated power at the time indicated by the white arrow represents a value deviated from the generated power estimated from the time dependence of the generated power of the sunny day. The generated-power values at those times can be corrected as generated-power values of the sunny day through linear interpolation with generated-power values therebefore and thereafter, which are determined to represent the generated power of the sunny day. The partly sunny day can be corrected to the day that is sunny all day through interpolation.

The partly sunny day that can be corrected to the day that is sunny all day through interpolation can be registered as an interpolable partly sunny day to the memory unit 12. As another example, the partly sunny day that can be corrected to the day that is sunny all day through interpolation may be corrected through interpolation of the value deviated from the data of the generated power, and the corrected data of the generated power may be registered as the day that is sunny all day to the memory unit 12.

The time dependence of the generated power (actual measurement value) of the selected day that is sunny all day (or partly sunny day that can be corrected to the day that is sunny all day) is approximated with a predetermined continuous function (F(t): t represents time) so that a power generation curve of the day that is sunny all day (referred to as “sunny power generation curve”) is obtained. The obtained sunny power generation curve represents a time dependence of the generated power of a day that is sunny all day.

The continuous function (F(t)) reproducing the generated power can be obtained from the time dependence of the generated power (actual measurement value) through regression analysis such as a least squares method, for example.

Regarding the predetermined function, for example, as shown in FIG. 2(B), it is divided into three regions of an A region, a B region, and a C region in order of process of time, a time that the A region starts is regarded as the power generation start time, and a time that the C region ends is regarded as the power generation end time. Further, an approximation function of the C region is obtained as an inversion (axial symmetry) of a function of the A region.

The approximation functions are continuously connected at the boundary between the A region and the B region and the boundary between the B region and the C region.

With the function including information on the power generation start time and the power generation end time, and with the functions of the A region and the C region having a relationship axisymmetric to each other, the number of parameters for deciding the approximation function can be reduced.

That is, the sunny power generation curve can be reproduced by a smaller number of parameters.

As a specific function, for example, a combination of trigonometric functions in the A region and the C region and a quadratic function in the B region can be used.

The power generation start time (time at which the generated power starts to be larger than 0) is represented by Ts, the power generation end time (time at which the generated power is reduced to become 0) is represented by Te, and the time period of each of the A region and the C region is represented by γ. When a time is represented by t, the A region falls within a range of Ts≤t≤Ts+γ, and the C region falls within a range of Te-γ≤t≤Te. As approximation formulae in the A region and the C region, the following functions can be adopted.

$$A region : dF ( t ) / dt = α * sin ( 2 π ( t - Ts ) / β ) \qquad ( Formula 1 )$$

$$C region : dF ( t ) / dt = α * sin ( 2 π ( Te - t ) / β ) \qquad ( Formula 2 )$$

Where, dF(t)/dt means a first-order derivative by time of F(t).

The approximation function in the B region is set to a quadratic function of the time t, and the coefficient of the second-order term for t is set to be negative. The approximation function in the B region is smoothly continuous to the approximation function of the A region at a boundary (t=Ts+γ) between the A region and the B region, and is smoothly continuous to the approximation function of the C region at a boundary (t=Te-γ) between the B region and the C region.

Note that the phrase “smoothly continuous” means that the function is continuous up to at least the first-order derivative.

The quadratic function for determining the approximation function of the B region is maximum at a middle (t=(Ts+Te)/2) of a time period in which the solar cell 2 generates power, and is uniquely set by the parameters α, β, and γ.

Note that the power generation start time and the power generation end time can be set to sunrise and sunset times that are determined from the date and the latitude and longitude. However, the power generation start time and the power generation end time can be corrected in consideration of the influence of the landscape and the feature around the solar cell 2.

The sunny power generation curve is acquired based on the actual measurement value of the generated power, and hence the continuous function reproducing the sunny power generation curve includes, for example, influences of an I-V characteristic of the solar cell 2 and performance of the PCS 3 for controlling the output of the solar cell 2.

Note that the function shape for approximating the sunny power generation curve is not limited to the above, and can be set as appropriate. However, with use of a function having symmetry as described above, the sunny power generation curve can be reproduced with use of a smaller number of parameters, and trend analysis over time of the sunny power generation curve is facilitated.

Further, when the sunny power generation curve obtained from the generated-power data has a complex shape, the approximation formula can also be obtained by a neural network through a universal approximation theorem.

Step 3: An annual transition curved line indicating a transition of one year of a total power generation amount of one day on the sunny day is obtained.

The generated power at each time is integrated from the sunny power generation curves of a plurality of days obtained in Step 2 so as to calculate a total power generation amount (referred to as “sunny-day total power generation amount”) of one day of each day. Thus, a transition of one year of the sunny-day total power generation amount (referred to as “annual transition curved line”) is obtained.

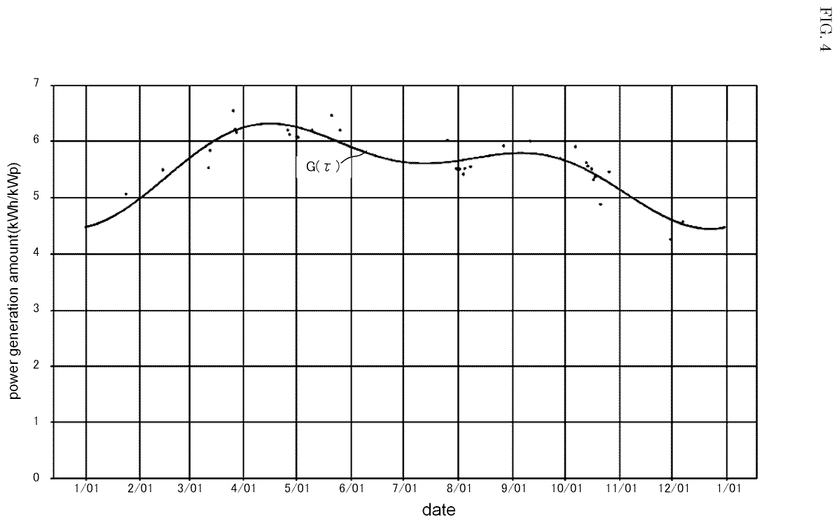

FIG. 4 is a graph showing an annual transition (day dependence) of the sunny-day total power generation amount, and further showing an annual transition curved line approximating the annual transition of the sunny-day total power generation amount. The vertical axis indicates the power generation amount, and the horizontal axis indicates time (day).

Each dot shown in FIG. 4 indicates the sunny-day total power generation amount, and the solid line indicates the annual transition curved line. FIG. 4 includes the sunny-day total power generation amount obtained from the sunny power generation curve of not only the day that is sunny all day but also the partly sunny day. The sunny-day total power generation amount is a value obtained by integrating F(t) from the power generation start time Ts to the power generation end time Te at the date (τ) of each dot.

Note that F(t) is also dependent on the date (τ) and is a function of t and t. Accordingly, F(t) is F(t)=F(τ,t) to be exact.

The approximation function (annual transition approximation function G(τ)) reproducing the day dependence of the sunny-day total power generation amount indicated by each dot of FIG. 4 is acquired through regression analysis. Where t indicates day.

The annual transition curved line can be expressed by the function G(τ).

The function G(τ) may be formed from, for example, a combination of two periodic functions.

As a specific function, for example, as expressed by Expression 3, the annual transition curved line may be formed through linear combination of a periodic function having a period of one year and a periodic function having a period of a half year.

$$G ( τ ) = a * sin ( 2 π * ( τ - b ) / 365 ) + c * sin ( 2 π * ( τ - d ) / 18 \; 2.5 ) + e \qquad ( Formula 3 )$$

Symbols a, b, c, d, and e are parameters.

When the annual transition curved line is approximated with a function formed through linear combination of two functions having different periods as Expression 3, the influence of an annual transition of the orbit of the sun, the climate, and geographic factors can be reflected.

Step 4: The sunny power generation curve is scaled so as to match the annual transition curved line to obtain a sunny power generation model (Fm(t)).

Since each sunny power generation curve is obtained for each sunny day, fluctuations are sometimes caused in the mutual relationship among the sunny-day total power generation amounts calculated from the respective sunny power generation curves.

The sunny-day total power generation amount gently changes, and hence is scaled by multiplying each sunny power generation curve by a correction coefficient so as to match the annual transition curved line.

For example, when the sunny-day total power generation amount obtained through integration using the sunny power generation curve of the sunny day (referred to as “selected day”) selected in Step 2 and the total power generation amount calculated from the annual transition curved line (referred to as “calculated total power generation amount”) do not match each other, the sunny power generation curve is multiplied by a correction coefficient Cm to obtain the sunny power generation model. The correction coefficient Cm for the selected day (τ) is calculated as follows.

$$Cm ( τ ) = [ Calculated total power generation amount ] / [ Sunny - day total power generation amount ] = G ( τ ) / \int F ( τ , t ) \qquad ( Formula 4 )$$

Note that Cm is a constant in the sense that it is not dependent on time (t), but is decided for each selected day (τ) (Cm=Cm(τ)). Accordingly, Cm(τ) is a function of day (τ).

The sunny power generation model (Fm(τ,t)) can be obtained by multiplying the sunny power generation curve of the selected day (τ) by the calculated correction coefficient Cm.

$$Fm ( τ , t ) = Cm ( τ ) \times F ( τ , t ) \qquad ( Formula 5 )$$

Step 5: Sunny power generation models of the entire year are obtained.

In order to obtain a sunny power generation model of a day other than the selected day, the sunny power generation model of the day other than the selected day is generated by interpolating, in the past data, sunny power generation models of a selected day (τ1; where τ1<τ) immediately before and a selected day (τ2; where τ2>τ) immediately after the day for which the sunny power generation model is created (sunny power generation model creation target day (τ)), namely by interpolating Fm(τ1,t) and Fm(τ2,t)). For example, as the interpolation method, for example, linear interpolation is adopted.

When the interpolated sunny power generation model is represented by Fm′(τ,t) and linear interpolation is adopted as an example, Fm′(τ, t) is as follows.

$${Fm}^{′} ( τ , t ) = Fm ( τ 1 , t ) + \{ ( τ - τ1 ) / ( τ2τ1 ) \} \times Fm ( τ 2 , t ) - Fm ( τ 1 , t ) \} \qquad ( Formula 6 )$$

Note that a correction coefficient Cm′(τ) may be calculated so that the sunny power generation model Fm′(τ,t) of the sunny power generation model creation target day (τ) obtained through interpolation matches the annual transition curved line, and Fm′(τ,t) may be scaled.

The correction coefficient Cm′(τ) can be calculated by the following expression similarly to Step 4.

Cm′(τ)=[Calculated total power generation amount]/[Total power generation amount of interpolated sunny power generation model])

$$= G ( τ ) / \int {Fm}^{′} ( τ , t ) \qquad ( Formula 7 )$$

The sunny power generation model Fm(τ, t) of the sunny power generation model creation target day (τ) can be calculated as follows.

$$Fm ( τ , t ) = {Cm}^{′} ( τ ) \times {Fm}^{′} ( τ , t ) \qquad ( Formula 8 )$$

Note that the interpolated sunny power generation model is expressed as Fm′(τ, t) and discriminated from Fm(τ, t) in order to facilitate the understanding.

As described above, the sunny power generation models of all days of one year can be obtained. All generated sunny power generation models are stored into the memory unit 12 together with the date and the time.

The sunny power generation model represents the time dependence of the generated power reflecting the annual transition on the basis of the actual measurement value of the generated power output from the power conditioning system 3 on the sunny day. Accordingly, the sunny power generation model can include not only the annual change of the amount of insolation but also the influence of the climate such as air temperature, and further can comprehensively reflect the characteristics of the solar cell 2 and the power conditioning system 3.

Note that, when the past data does not have selected days before and after the day (sunny power generation model creation target day (τ)) for which the sunny power generation model is created but has only one selected day (τ1 or τ2) before or after the sunny power generation model creation target day (τ), the sunny power generation model of this sunny power generation model creation target day is adopted as the sunny power generation model of the selected day immediately before or after the sunny power generation model creation target day. However, in this case, the sunny power generation model may be calculated by multiplying the latest sunny power generation model by a correction coefficient Cm′ calculated with use of the latest sunny power generation model so as to match the annual transition curved line.

$${Cm}^{′} = [ Calculated total power generation amount ] \text{} / [ Total power generation amount of latest sunny power generation model ] \qquad ( Formula 9 )$$

For example, let either τ1 or τ2 be τk, the following expression is satisfied.

$${Cm}^{′} ( τ ) = G ( τ ) / \int Fm ( τ k , t ) \qquad ( Formula 10 )$$

Thus, the sunny power generation model Fm(τ, t) of the sunny power generation model creation target day (τ) can be calculated as follows.

$$Fm ( τ , t ) = {Cm}^{′} ( τ ) \times Fm ( τ k , t ) \qquad ( Formula 11 )$$

Moreover, in order to reproduce the power generation start time and the power generation end time of the sunny power generation model creation target day, the power generation start time and the power generation end time may be calculated from the latitude and the longitude, and the time axis may be scaled (power generation time period is reduced of expanded) with respect to the above-mentioned sunny power generation model obtained as a constant multiple.

For example, when the power generation start time and the power generation end time calculated from the sunrise and the sunset of the sunny power generation model creation target day are represented by T1i and T1e, respectively, the power generation start time of the latest selected day is represented by T0i, and the power generation end time thereof is represented by T0e, the power generation time period of the sunny power generation model of the selected day may be scaled (multiplied by (T0e−T0i)/(T1e−T1i)) with a time at the middle between the power generation start time and the power generation end time being set as a center. For example, when a time Tc at the middle between the power generation start time and the power generation end time is represented by Tc=(T1e+T1s)/2, correction is allowed with the following formula 12.

$$Fm ( τ , t ) = {Cm}^{′} ( τ ) \times Fm ( τ k , Tc + α x ( t - Tc ) ) \qquad ( Formula 12 )$$

Note that, also with respect to the sunny power generation model Fm(τ, t) obtained through interpolation described above, in order to reproduce the power generation start time and the power generation end time of the sunny power generation model creation target day, the scaling (or adjustment) of the time period may be performed as follows.

$$Fm ( τ , t ) = {Cm}^{′} ( τ ) \times {Fm}^{′} ( τ , Tc + α x ( t - T c ) ) \qquad ( Formula 13 )$$

Step 6: A weather coefficient corresponding to each weather is calculated.

The actual-measurement power generation amount at each weather (cloud cover) and the sunny power generation model are compared with each other, and an average value of a ratio between the actual-measurement generated power and the generated power of the sunny power generation model for the cloud cover at each time is defined as a weather coefficient (Rw) so that the weather coefficient with respect to each cloud cover is calculated. The generated-power prediction device 1 stores the weather coefficient into the memory unit 12 so as to correspond to the cloud cover.

$$Rw ( \text{} Cloud cover ) = < [ \text{} Actual - measurement generated power ] \text{} / [ Generated power of sunny power generation model ] > \qquad ( Formula 14 )$$

Where, symbols <> represent an average value.

An average is, for example, the arithmetic mean of a plurality of ratios obtained at respective time.

Note that, as described above, the cloud cover of the corresponding time can be acquired from the Internet 4, and the weather data stored in advance in the memory unit 12 can be used.

The weather coefficient is determined for each cloud cover, and enables to calculate the generated power corresponding to the cloud cover from the generated power of the sunny power generation model.

As described below, the cloud cover can be set to have, for example, five stages.
Level 1: Cloud cover of 10% or less (corresponding to sunny)
Level 2: Cloud cover of 11% or more and 25% or less
Level 3: Cloud cover of 26% or more and 50% or less
Level 4: Cloud cover of 51% or more and 84% or less
Level 5: Cloud cover of 85% or more and 100% or less

The weather coefficient Rw is determined as a function Rw(L) dependent on a level L.

Note that Rw(L) can be calculated from the actual measurement value of the generated power of each date stored in the memory unit 12, and is thus calculated by an average value of a plurality of ratios obtained corresponding to the cloud cover L.

$$Rw ( L ) = < [ Actual - measurement generated power ] \text{} / [ Generated power of sunny power generation model ] > \qquad ( Formula 15 )$$

Where, symbols <> represent an average value.

Step 7: The generated power of the prediction target day is predicted.

The generated-power prediction device 1 acquires the weather forecast of the prediction target day of an area in which the solar cell 2 is installed from the Internet 4. The weather forecast includes the forecast of the cloud cover (L) of each time (t) of the prediction target day (τ).

The generated-power prediction device 1 reads out the weather coefficient (Rw(L)) and the sunny power generation model (Fm(τ, t)) corresponding to the date (τ) of the prediction target day from the memory unit 12, and multiplies, for each time (t), the generated power of the sunny power generation model by the weather coefficient corresponding to the cloud cover so as to calculate the generated power, and obtains a prediction generated power (Pf(τ, t)) which is a prediction value of the generated power.

As described below, the prediction generated power (Pf(τ, t)) can predict the generated power for each time (t), and provides the time dependence of the predicted generated power.

$$Pf ( τ , t ) = Rw ( L ) \times Fm ( τ , t ) \qquad ( Formula 16 )$$

From Step 1 to Step 7 described above, the generated-power prediction device 1 can obtain the prediction generated power Pf(τ, t) for each time (t) of the prediction target day (τ).

A program for executing Step 1 to Step 7 described above in this order is stored in the memory unit 12, and the arithmetic processing unit 11 executes the prediction of the generated power in accordance with the stored program.

The arithmetic processing unit 11 can output the generated power of the prediction target day to the display device 13, and may be configured to output the generated power of the prediction target day to an external control device such as a computer.

Note that the configuration of the memory unit 12 is not particularly limited. The memory unit 12 can be incorporated in the arithmetic processing unit 11 or may be externally provided.

Further, the generated-power prediction device 1, that excuse the above-mentioned steps, may take various configurations as described above.

Note that the processing from Step 1 to Step 7 described above can be entirely executed automatically, but an operator may be interposed in a part of the above-mentioned steps or in each step so that Step 1 to Step 7 described above are executed in order while the results and the like are checked. The present invention does not exclude human operation in the execution of the processing.

The power generation prediction device 1 can be incorporated in an existing solar power generation system. Accordingly, the solar power generation system 100 capable of predicting the solar-generated power can be easily constructed.

### Second Embodiment

In Step 2 described above, as the selected day (selected sunny day), in addition to the day that is sunny all day, a partly sunny day that can be corrected to the day that is sunny all day has been adopted. However, even a partly sunny day that cannot be corrected to the day that is sunny all day through interpolation can also be adopted as the selected day. As described below, the generated-power prediction device 1 can select a day for which a sunny curve can be calculated from data of the generated power stored in the memory unit 12, and can calculate the sunny curve.

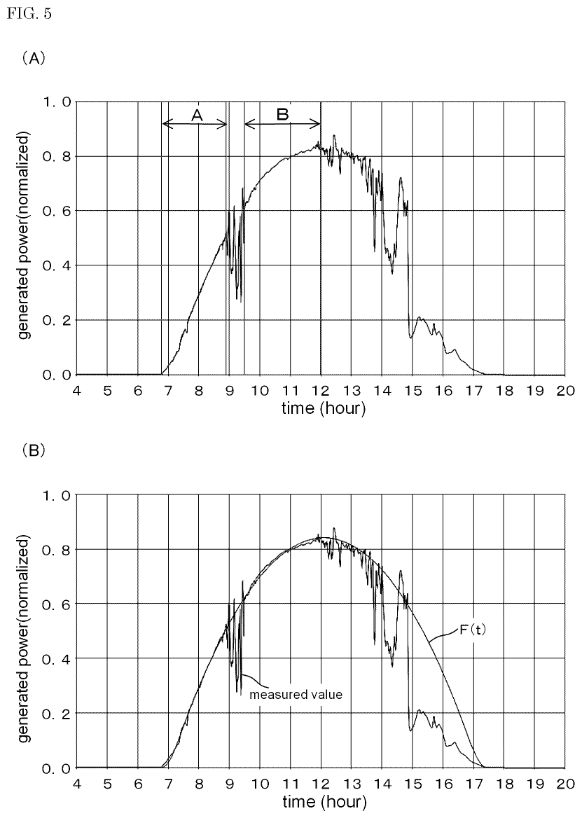

FIG. 5(A) shows an example of a partly sunny day that cannot be corrected to the day that is sunny all day through interpolation, and FIG. 5(B) shows an example of a sunny power generation curve created based on the actual measurement value of the generated power of the partly sunny day.

The sunny power generation curve F(t) shown in FIG. 5(B) adopts a function in which the trigonometric functions and the quadratic function are combined as described above so as to be axisymmetric with respect to the time axis at the middle of the power generation time period.

In FIG. 5(A), the generated-power values in a time zone (time domain) A and a time zone (time domain) B can be regarded as the generated-power values at a sunny time, but the generated-power values in other time zones greatly increase or decrease in a unit of minutes of about five minutes, and thus the generated-power value cannot be interpolated to obtain the generated power of the sunny day.

However, when a time period in which the weather is sunny (sunny time period) is present for a predetermined percentage, for example, 40% or more of the total power generation time period (time period from the power generation start time to the power generation end time), a function reproducing the sunny power generation curve can be obtained by using only the actual measurement value of the generated power in the time zone that can be regarded as sunny.

The number of days for which the sunny power generation curve can be calculated is increased. Thus, the number of data points for forming the annual transition curved line is increased, and an effect of increasing the accuracy of prediction can be obtained.

In the example shown in FIG. 5(A), the power generation start time is 6:46 and the power generation end time is 17:23, and the total power generation time period is 637 minutes. The time zone A and the time zone B that can be regarded as sunny are 126 minutes and 148 minutes, respectively, which are 274 minutes in total. Thus, the total sunny time period is 43% of the total power generation time period.

FIG. 5(B) shows a result of performing regression analysis while excluding the generated-power values in zones other than the time zone A and the time zone B and using only the generated-power values in the time zone A and the time zone B. As shown in FIG. 5(B), even for the partly sunny day that cannot be corrected to the day that is sunny all day through interpolation, the sunny power generation curve can be obtained as long as the day is a sunny curve calculable day.

Note that a day that is sunny all day, a day that can obtain power to be capable of being corrected to the day that is sunny all day through interpolation, and a day that is difficult to be corrected to the day that is sunny all day but capable of partly obtaining generated power equivalent to that of the sunny day for a predetermined time period or more are sometimes referred to as “sunny curve calculable day.”

The arithmetic processing unit 11 of the generated-power prediction device 1 can automatically discriminate whether or not each day stored in the memory unit 12 is the sunny curve calculable day, from the generated power stored for each day in the memory unit 12.

Description is hereinafter given of an automatic discrimination method of the sunny curve calculable day.

For automatic discrimination of the sunny curve calculable day, it is required to judge, from the data of the generated power shown in FIG. 5(A), that a time zone in which the generated power greatly increases or decreases in a unit of minutes is not sunny and exclude this time zone.

The arithmetic processing unit 11 reads out the data of the generated power stored in the memory unit 12, and defines a predetermined time intervalΔT (for example, 5 minutes) to determine whether or not each time is sunny from the dependence with respect to the predetermined time interval.

The arithmetic processing unit 11 can execute the following determination processes with respect to each time t in order from the starting time Ts.

### Determination Process 1:

When a total variation amount (|P(t)−P(t+δt)|+|P(t+δt)−P(t+2δt)|+ . . . +|P(t+ΔT−δt)−P(t+ΔT)|) of the generated power from the time t to a time t+ΔT is a certain value or more, it is judged (determined) that the weather is not sunny.

Note that P(t) represents the generated power at the time t, δt represents a measurement time interval (or output time interval of the actual measurement value) of the generated power P(t), and symbols Il represent an absolute value.

### Determination Process 2:

When the integrated value of the generated power from the time t to the time t+ΔT is smaller than the integrated values of the generated powers of ΔT on both sides, that is, smaller than the integrated value of the generated power from a time t-ΔT to the time t and also smaller than the integrated value of the generated power from the time t+ΔT to a time t+2ΔT, it is judged (determined) that the weather is not sunny.

### Determination Process 3:

When the integrated value of the generated power from the time t to the time t+ΔT is smaller than an average of the integrated value of the generated power from the time t to the time t+ΔT of fifteen days before and after the target day, it is judged that the weather is not sunny.

The arithmetic processing unit 11 executes the above-mentioned determination processes 1, 2, and 3, and judges (determines) that the weather is not sunny at the time t when it is determined that the weather is not sunny in any one of the determination processes 1, 2, and 3.

Note that the execution order of the determination processes 1, 2, and 3 is not limited and may be freely selected.

The arithmetic processing unit 11 excludes the time judged as not sunny by the above-mentioned determination processes from the power generation time period (from the power generation start time to the end time), and judges the time period remaining after the exclusion as sunny.

The arithmetic processing unit 11 calculates the sum total of the time periods determined as sunny. The arithmetic processing unit 11 recognizes a day in which the sum total of the time periods determined as sunny is a predetermined time percentage (for example, 40%) or more as the sunny curve calculable day, and registers this day as the sunny curve calculable day to the memory unit 12. In addition, the arithmetic processing unit 11 can register the time period judged as sunny in this sunny curve calculable day.

The arithmetic processing unit 11 of the generated-power prediction device 1 can perform regression analysis with use of only the actual measurement value of the time period judged as sunny of the generated power of the sunny curve calculable day stored in the memory unit 12, to thereby obtain the sunny power generation curve.

### Third Embodiment

In the above-mentioned embodiment, the weather coefficient has been decided depending on the cloud cover. The weather coefficient may be defined so as to change depending further on a season or a time zone. For example, the amount of insolation applied to the solar cell 2 is considered to be affected by not only the cloud cover but also an amount of water vapor in the atmosphere, and is also considered to be influenced by air temperature or humidity.

Accordingly, the weather coefficient may be calculated in accordance with each weather for each month, and recorded into the memory unit 12 of the generated-power prediction device 1. The weather coefficient may be selected in accordance with the month of the prediction target day, which may be used together with the cloud cover of the weather forecast so as to predict the generated power.

Further, in some cases, the weather coefficient is also dependent on time due to, for example, a change in a ratio between a direct incidence component (normal incidence component) of sunlight and an incidence component (scattering component) of sunlight that is scattered by the cloud, which is dependent on the orientation of the solar cell 2.

Accordingly, the weather coefficient may be calculated for each time or each time zone, and recorded in the memory unit 12 of the generated-power prediction device 1. The weather coefficient may be selected in accordance with the time of the prediction target day, which may be used together with the cloud cover of the weather forecast so as to predict the generated power.

When the weather coefficient (Rw) is defined for each month, the weather coefficient (Rw) can be calculated for each month in accordance with Formula 14 or Formula 15 to decide the average value.

The weather coefficient (Rw) is dependent on the month (M) and the cloud cover (L), and hence can be expressed as follows.

$$Rw ( L ) = Rw ( M , L ) \qquad ( Formula 17 )$$

Further, in Rw(M,L), the weather coefficient may be set for every plurality of months, for example, three months so that the weather coefficient is set for each season. As shown in FIG. 4, the annual transition has two local maximums and two local minimums, and hence the seasons may be set so as to include those local maximums and local minimums.

Further, when the weather coefficient (Rw) is defined for each time zone, for example, the power generation time period (from the power generation start time to the end time) can be divided into a plurality of time sections, for example, three sections, and decided. As the division, for example, the power generation time period can be equally divided. Further, for example, the continuous function F(t) reproducing the generated power may be formed of three types of functions as in the above-mentioned example so as to be divided into the three regions of the A region, the B region, and the C region as shown in FIG. 2(B).

When the weather coefficient (Rw) is defined for each time section of the power generation time period, the weather coefficient (Rw) can be calculated in accordance with Formula 14 or Formula 15 for each time section so as to decide the average value.

The weather coefficient (Rw) is dependent on the time section (J) and the cloud cover (L), and hence can be expressed as follows.

$$Rw ( L ) = Rw ( J , L ) \qquad ( Formula 18 )$$

Note that, when the weather coefficient (Rw) is defined for each month and each time section, the weather coefficient (Rw) can be obtained by averaging the value obtained in accordance with Formula 15 for each month (M) and each time section (J).

In this case, the weather coefficient (Rw) is dependent on the month (M) and the time section (J) in addition to the cloud cover (L), and hence can be expressed as follows.

$$Rw ( L ) = R w ( M , J , L ) \qquad ( Formula 19 )$$

As described above, when the weather coefficient (Rw) is defined as a function dependent on month, season, or time, finer prediction of generated power is allowed.

### Fourth Embodiment

The solar power generation system 100 sometimes have the solar cell 2 oversized thereon in order to improve the total power generation amount. In such a configuration, for example, near noon having a large amount of insolation, the generated power that can be output from the solar cell 2 may be larger than the rated capacity of the PCS 3.

As described in the above-mentioned example, the generated power output from the solar cell 2 may be restricted by the rated power of the PCS 3. Note that a state in which the generated power is restricted by the rated power of the PCS 3 and no generated power is output any more is referred to as “peak shaving.”

When peak shaving occurs, the generated power output from the PCS 3 becomes equal to the rated power of the PCS 3.

Description is hereinafter given of power generation prediction of the solar power generation system 100 in a case in which peak shaving occurs.

In this embodiment, changes are made to the power generation prediction method of the first embodiment in the following steps.

### Step 2:

In the step of Step 2 described above, whether or not the peak shaving has occurred is determined at a predetermined time interval, for example, for each minute, in the generated power data of the selected sunny day, and the time at which the peak shaving has occurred is excluded from the sunny time so that the sunny power generation curve is calculated from the time at which no peak shaving has occurred.

Whether or not the peak shaving has occurred is determined by determining whether or not the value of the generated power output from the PCS 3 is the same as the rated output (rated power) of the PCS 3.

An approximation function reproducing the generated power of the remaining time that is not excluded, that is, the time at which the value of the generated power output from the PCS 3 is equal to or lower than the rated output of the PCS 3 is obtained through regression analysis such as a least squares method, and thus the sunny power generation curve is obtained.

Note that, in some cases, for example, due to influences such as the characteristic of the control of the PCS 3, the generated power obtained when the peak shaving has occurred fluctuates at a value lower than the rated output. In this case, the value of the generated power output from the PCS 3 is not always completely the same as the rated output of the PCS 3. It may be determined that the peak shaving has occurred when the value of the generated power output from the PCS 3 is close to the rated output, that is, a difference from the rated output falls within a predetermined range (for example, within 5% of the rated output), and further the difference falls within the predetermined range continuously for a predetermined time period or more (for example, ten minutes or more).

Accordingly, it is determined whether or not the value of the generated power output from the PCS 3 is substantially equivalent to the rated output of the PCS 3. Note that “substantially equivalent” means the same or means that the difference falls within a predetermined range.

### Step 7:

In the step of Step 7 described above, the generated-power prediction device 1 compares the prediction generated power Pf(τ, t) predicted for each time (t) of the prediction target day (τ) and the rated output of the PCS 3 to each other, and adopts the minimum value as the prediction generated power that is a prediction value of the generated power at this time.

$$Pf ( τ , t ) = min ( Pf ( τ , t ) , [ Rated output of PCS 3 ] ) \qquad ( Formula 20 )$$

Note that “min” in Formula 20 is a function that outputs the minimum value. When Pf(τ, t) and the rated output of the PCS 3 are the same value, this value is output.

### Fifth Embodiment

The prediction generated power after the prediction target day can be corrected through comparison between the generated power which is actually measured on the prediction target day or a power generation amount which is an integrated value of the actually-measured generated power and the predicted generated power or a power generation amount which is an integrated value of the predicted generated power.

In this manner, the accuracy of the prediction of the generated power can be further improved.

### Correction Method 1:

The actually-measured power generation amount and the predicted power generation amount for the prediction target day are compared with each other so that a ratio therebetween is calculated as a power generation amount correction ratio (Rp).

$$Rp = [ Actually - measured power generation amount ] \text{} / [ Predicted power generation amount ] \qquad ( Formula 21 )$$

The prediction generated power is multiplied by the obtained power generation amount correction ratio to correct the prediction generated power thereafter (after the prediction target day).

For example, the power generation amount correction ratio is calculated from the power generation amount actually measured on the prediction target day X/Y (X month/Y day) and the power generation amount obtained by integrating the prediction generated power, and the prediction generated power is multiplied by the power generation amount correction ratio so that the prediction generated power at X/(Y+1)(X month/Y+1 day) and thereafter is corrected.

Note that the power generation amount correction ratio may be stored in the memory unit 12.

Further, when the prediction target day X/Y is the sunny curve calculable day, the sunny power generation curve may be obtained from the data of the actually-measured generated power. An integrated value of the sunny power generation curve may be used in place of [Actually-measured power generation amount] in Formula 21, and an integrated value of the predicted sunny power generation model at X/Y may be used in place of the [Predicted power generation amount].

The sunny power generation model after the prediction target day may be corrected with use of obtained Rp, and the corrected sunny power generation model may be stored in the memory unit 12.

Note that Rp can be used to correct the sunny model, and hence is referred to as “sunny model correction ratio.”

### Correction Method 2:

On the prediction target day, the generated power can be further adjusted after power generation is started.

That is, the generated power for each time predicted before the prediction target day may be corrected with use of the actual measurement value of the generated power obtained after the power generation is started.

When the weather is sunny during a predetermined time period after the power generation is started on the prediction target day, the integrated value of the actually-measured generated power during this time period in which the weather is sunny and the integrated value of the predicted generated power are compared to each other, and a ratio therebetween (=[Integrated value of actually-measured generated power]/[Integrated value of predicted generated power]) is calculated as the generated power correction ratio Rp. The predicted generated power is multiplied by the correction ratio so that the prediction generated power after the above-mentioned predetermined time is revised.

For example, the power generation start time is a time A, and the weather is sunny during a period from the time A to a time B. The generated power correction ratio Rp is calculated from an integrated value obtained by integrating the actual measurement value of the generated power from the time A to the time B and an integrated value obtained by integrating the predicted generated power from the time A to the time B. The prediction generated power is corrected by multiplying the prediction generated power after the time B by the calculated generated power correction ratio Rp.

### Correction Method 3:

The weather coefficient can also be corrected. At each time of the prediction target day, the actual measurement value of the generated power can be obtained, and further weather observation data, for example, the cloud cover can be obtained via the Internet.

Accordingly, the weather coefficient Rw can be calculated by Formula 14 and can be kept updated.

Note that the calculated weather coefficient Rw may be updated as the weather coefficient Rw defined for each month or for each time section.

### INDUSTRIAL APPLICABILITY

According to the present invention, it is possible to provide a power generation system capable of predicting generated power of solar power generation from data of past generated power, weather information, and a weather forecast of a prediction day, without using a pyranometer. An existing solar power generation system can be utilized, and thus the industrial applicability is wide.

### REFERENCE SIGNS LIST

100 solar power generation system
1 generated-power prediction device
   11 arithmetic processing unit
   12 memory unit
   13 display device
   14 input device
2 solar cell
3 power conditioning system
4 Internet

1. A prediction method of generated power for a solar power generation system including a solar cell and a power conditioning system, the prediction method comprising:
a first step of storing past data obtained by associating weather data and power generation data of the solar cell output via the power conditioning system for at least one year before a prediction target day of the generated power;
a second step of obtaining a sunny power generation curve from a generated-power value of a day selected from the past data;
a third step of obtaining an annual transition curved line indicating an annual transition of a total power generation amount obtained by integrating the sunny power generation curve;
a fourth step of obtaining a sunny power generation model by scaling the sunny power generation curve so as to match the annual transition curved line;
a fifth step of obtaining the sunny power generation model for all days in one year;
a sixth step of obtaining a weather coefficient corresponding to each weather; and
a seventh step of acquiring a weather forecast of the prediction target day and predicting the generated power to be output from the power conditioning system from the weather coefficient and the sunny power generation model of the prediction target day,
the steps being executed in the stated order.

2. The prediction method of generated power according to claim 1, wherein the sunny power generation curve is expressed by a function that is axisymmetric with respect to a time axis at a middle of a power generation time period.

3. The prediction method of generated power according to claim 1, wherein, in the second step, the selected day has a total sunny time period of 40% or more with respect to a total power generation time period.

4. The prediction method of generated power according to claim 1, wherein the weather coefficient is defined for each time or each month.

5. The prediction method of generated power according to claim 1,
wherein, in the second step,
a generated-power prediction device obtains the sunny power generation curve based on a generated-power value at a time at which the generated-power value becomes equal to or lower than rated output of the power conditioning system, and
wherein, in the seventh step, a minimum value between the rated output and the prediction generated power calculated from the weather coefficient and the sunny power generation model at each time is adopted as the prediction generated power of the corresponding time.

6. The prediction method of generated power according to claim 1, wherein, through comparison between generated power output from the power conditioning system actually measured on the prediction target day, and a prediction generated power, the prediction generated power after the prediction target day is corrected.

7. A solar power generation system comprising a solar cell, a power conditioning system, and a generated-power prediction device,
the generated-power prediction device being configured to execute the prediction method described in claim 1.

8. A generated-power prediction device for predicting generated power of a solar power generation system including a solar cell and a power conditioning system,
the generated-power prediction device comprising an arithmetic processing unit and a memory unit,
the arithmetic processing unit being configured to execute the prediction method described in claim 1.
